(19) United States
(12) Patent Application Publication
(10) Pub. No.: US 2014/0324856 A1
(43) Pub. Date: Oct. 30, 2014

(54) APPLICATION DISCOVERABILITY

(71) Applicant: MICROSOFT CORPORATION, Redmond, WA (US)

(72) Inventors: Limor Lahiani, Tel Aviv (IL); Eran Yariv, Zichron Yaakov (IL); Dima Stopel, Herzliya (IL); Benny Schlesinger, Ramat Hasharon (IL)

(73) Assignee: Microsoft Corporation, Redmond, WA (US)

(21) Appl. No.: 13/872,098

(22) Filed: Apr. 27, 2013

(51) Int. Cl. G06F 17/30

(52) U.S. Cl. CPC G06F 17/30861
USPC 707/736

(57) ABSTRACT

Architecture that enables the discovery of relevant applications, where the relevance is personalized to the user and user interests. New, relevant, and interesting applications are personalized to the user based on friends and/or people with whom the user shares common interests (e.g., social networks), based on queries for a popular application within a geographical area, and/or collaborative filtering. Moreover, users who employ the disclosed architecture can maintain anonymity to prevent the exposure of personal identifying details. Social-based application discovery, location-based application discovery, anonymous-profile-based application discovery, and collaborative-filtering-based application discovery, are provided. Application installs, uninstalls, and frequency of user interaction are also available, as well as privacy modes for privacy protection.

### BACKGROUND

The number of web and device (e.g., mobile, tablet, etc.) applications is rapidly growing, and consequently, discovering a relevant application is becoming equally problematic. One survey indicates there are approximately thirteen hundred new applications published every day. The ways in which a user discovers these new applications for personal needs are primarily through browsing the application market place, reading blog posts, and by word-of-mouth, each of which is becoming less effective given the enormity of the applications from which to choose.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables the discovery of relevant applications, where the relevance is personalized to the user and user interests such as related at least to the user, what the user is doing now, what is the user/device context, what the user has done in the past given the current similar circumstances, and so on. New, relevant, and interesting applications are personalized to the user based on friends and/or people with whom the user shares common interests, based on queries for a popular application within a geographical area, and/or collaborative filtering based on other users, data sources, past actions of the user (the user bought product A in the past, it is likely the user will by product A now), etc. Collaborative filtering can be applied to the context and the domain, for example. Moreover, users who employ the disclosed architecture—the seeking user and the other users from which the discovered (suggested) application is provided—can maintain anonymity to prevent the exposure of personal identifying details.

The context of the device/user is identified and the context is represented by the context information. The context component can be a program (module) that accesses system programs, algorithms, and data, such as associated with the operating system, to extract log information as to the programs that have been installed, uninstalled, updated, and the amount of user activity in using the program. The context information can comprise a wide variety of information, including but not limited to, personal information (e.g., user profile, user preferences, login credentials, etc.), user interests, and device application information (e.g., when installed, if uninstalled, updates and when updated, the amount of user activity using the device applications, etc.), device geographical location, for example, as well as any other information that relates to the device subsystems, device software and hardware, what the user is doing/operating/running on the device, what the user is doing when not interacting with the device (e.g., walking), what the user has been doing, what the user might be going to do, and so on.

More specifically, the disclosed architecture enables social-based application discovery by way of friends or people of interest known to the user and/or who have similar interests. The disclosed architecture also enables location-based application discovery whereby a user can discover popular applications within a geographical area, such as to obtain recommendations on restaurants, events, maps, and entertainment in the geographical area.

The disclosed architecture also enables anonymous-profile-based application discovery. Rather than personally identifying information, the discovered applications are determined based on the user's interest profile, which does not disclose the user identity, and the user can obtain/get a list of popular applications among the other users who share similar interests.

The disclosed architecture also enables collaborative-filtering-based application discovery to get/obtain recommendations on relevant applications used by people who use similar applications. This can be accomplished by applying a collaborative-filtering approach to receive recommendations from other users on applications that the user might find interesting. The collaborative filtering can take into consideration not only the context of the user device, but also the domain, as well as other considerations, as desired.

The disclosed architecture can also access additional application information, such as an update (or application log data) obtained as to uninstalled applications and installed applications. Moreover, application usage can be identified to measure application popularity in an improved way. Application usage can be measured and analyzed to determine which applications are not only used most frequently, but also, actually occupy the most time with respect to user interaction. Additionally, when sharing an application, the user can specify whether to share zero, one, or more of the download, uninstall, and usage information.

The disclosed architecture utilizes a pull model whereby the user/user device/network processes and seeks out the desired application discovery information; however, it is within contemplation that a push model can be employed wherein the architecture pushes one or more applications to the user based on the user context and other criteria such as user geographical location, and applications other users have used when in operating under similar conditions, for example. In this latter case, the user can then be notified of the pushed application(s) to make a selection of one or more applications to review and install. The pushed applications can be ranked according to popularity, for example. Alternatively, the user can choose to automatically let the system select and install the top one or two applications automatically without user intervention.

The disclosed architecture also provides and enables privacy protection to manage privacy, even without sharing any identifying information. The user can choose to share an application identity or keep the application identity private. When the application identity is shared, the identity can be made “visible” to a permitted audience. Additionally, the user can control the visibility of the user profile by setting the desired privacy mode. The privacy modes include, but are not limited to, public, semi-public, anonymous, and hybrid. Moreover, the user can simply choose to share one or more of the user applications for anyone to see without a user profile.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system of privacy processing in accordance with the disclosed architecture for the authorized and secure handling of user information.

FIG. 3 illustrates a system of an exemplary protocol for context information and privacy management.

FIG. 4 illustrates a system of application install and usage as a metric for application popularity.

FIG. 5 illustrates a system where the disclosed application discovery is incorporated with an operating system search capability.

FIG. 6 illustrates a method in accordance with the disclosed architecture.

FIG. 7 illustrates an alternative method in accordance with the disclosed architecture.

FIG. 8 illustrates a block diagram of a computing system that executes application discovery in accordance with the disclosed architecture.

### DETAILED DESCRIPTION

The disclosed architecture enables the discovery of relevant applications, where the relevance is personalized to the user and user interests. New, relevant, and interesting applications are personalized to the user based on friends and/or people with whom the user shares common interests (e.g., social networks), based on queries for a popular application within a geographical area, and/or collaborative filtering. Moreover, users who employ the disclosed architecture can maintain anonymity to prevent the exposure of personal identifying details. Social-based application discovery, location-based application discovery, anonymous-profile-based application discovery, and collaborative-filtering-based application discovery, are provided. For example, the user can actually post/publish the applications the user is using (e.g., on a given device), and if desired, in what domains and under what conditions (e.g., geolocation understanding, event planning, scheduling, picture processing, etc.). Application installs, uninstalls, and frequency of user interaction are also available, as well as privacy modes for privacy protection.

The disclosed architecture can utilize a pull or a push model whereby the user/user device/network processes and seeks out the desired application discovery information and/or the architecture suggests (pushes) applications to the user based on the context such as user geographical location, and applications other users have used when in operating under similar conditions, for example.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

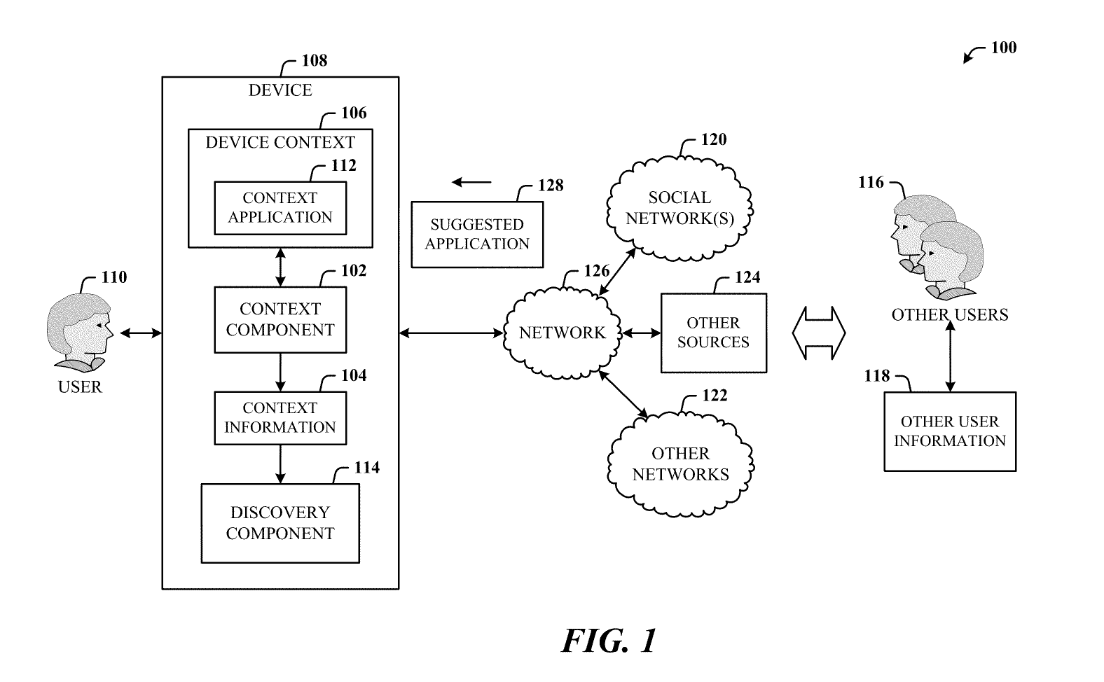

FIG. 1 illustrates a system 100 in accordance with the disclosed architecture. The system 100 can include a context component 102 that identifies context information 104 of a device context 106 of device 108 of a user 110. The device context 106 is represented by the context information 104. The context component 102 can be a program (module) that accesses system programs, algorithms, and data, such as associated with the operating system, to extract log information as to the programs that have been installed, uninstalled, updated, and the amount of user activity in using the program.

Based on the information found via the context component 102, the context information 104 can include, but is not limited to, a wide variety of information, such as personal information (e.g., user profile, user preferences, login credentials, etc.), user interests, and device application information (e.g., when installed, if uninstalled, updates and when updated, the amount of user activity using the device applications, etc.) of a context application 112. The context information 104 can also include device geographical location, for example, as well as any other information that relates to the device subsystems, device software and hardware, what the user 110 is doing/operating/running on the device 108, what the user 110 is doing when not interacting with the device 108 (e.g., walking), what the user 110 has been doing, what the user might be going to do, and so on.

As an example, if the user 110 is walking quickly down a sidewalk of a city, and while in the rain, all of these actions and associated data can be included as part of the context information 104, which can be enabled by the user 110 for automatic detection and computation by the user device 108 (and in robust implementations, as well by systems external to the device 108 that cooperate to assist in providing data, detecting, and computing the context information 104, and hence, the device context 106).

Geolocation information (e.g., latitude/longitude coordinates) can be obtained using a geolocation subsystem such as global positioning system (GPS), user gate can be detected using an accelerometer, user heading (direction of movement) can be computed using a device gyroscope and/or the geolocation subsystem, the weather conditions of the geographical area (which includes the city) can be determined by the automatic access of a web-based weather site, the software launched on the device 108 to perform these functions can be logged, data related to each of these functions and subsystems can be logged, and so on.

Additionally, if the user device 108 is a smartphone, for example, and the user 110 is talking on the phone, this is additional context information 104 that can be captured, such as the software used to facilitate the call. The device 108 can also be a vehicle mounted/integrated device provided with the purchase of a vehicle or installed thereafter suitably designed to include some or all of the capabilities described herein.

The system 100 can also comprise a discovery component 114 that accesses other users 116 (e.g., the other users themselves, the other user devices, etc.) and associated other user information 118 according to a privacy profile (e.g., public, semi-public, hybrid, and anonymous), and discovers a suggested application 128 relevant to the device context 106 based in part on the context information 104. The “accessing” by the discovery component 114 also includes receiving a suggested application or applications from the architecture as computed by the architecture based on the user/device context.

The automatic discovery process for determining suggested applications can comprise algorithms (locally and/or externally) that interface to the discovery component 114 and process the context information 104 against the sources (e.g., social networks 120, other networks 122, other sources 124, etc.), the other users 116, and the other user information 118. Alternatively, or in combination therewith, the discovery component 114 can handle this locally and thereby directly interface to the sources (e.g., social networks 120, other networks 122, other sources 124, etc.), the other users 116, and the other user information 118.

The algorithms can also analyze user communications (e.g., blog entries, messaging text, etc.) to derive the suggested applications therefrom. The algorithms can also access stored information about users the user 110 is familiar with or knows, and accumulated data about applications installed, uninstalled, etc.

The capabilities described herein can be employed as a standalone application for the user device. Alternatively, the capabilities can be employed as part of an online application store that is accessible and usable by a given user.

The discovery component 114 can access the other users 116, and the other user information 118 as obtained from social networks 120, other networks 122 (e.g., business, enterprise, etc.), and other sources 124 (e.g., blogs, messages, email, user devices, etc.) via a network 126 such as the Internet, and/or cellular networks.

The disclosed architecture also enables social-based application discovery. The user 110 can follow friends or people of interest (the other users 116), and get/receive updates related to the list of applications downloaded and used by these users (the other user information 118). For example, the user 110 may follow a famous fashion designer and get updates about the applications the fashion designer uses. Alternatively, the user 110, interested in fitness and health, can follow friends who share the same interests, and then discover applications in that category that the friends may use.

The disclosed architecture also enables location-based application discovery. The user 110 can discover popular applications within a geographic region. For example, if the user 110 is on a business trip to Seattle, the user 110 can discover a Seattle-specific application that is popular among people who live in Seattle area and/or from other users who have traveled to Seattle, and download the application to obtain recommendations on restaurants, events, maps, and other entertainment in the Seattle area.

The disclosed architecture also enables anonymous-profile-based application discovery. The user 110 can benefit from this solution even without sharing the user's identity publicly and without disclosing personal information. The user 110 is provided a way to share profile attributes and interests anonymously (explicitly or implicitly). The discovered applications are associated with the user's interest profile, and the user can obtain/get a list of popular applications among the other users 116 who share similar interests.

For example, User A (e.g., as one of the other users 116 or the user 110) is interested in hiking, but is concerned about privacy and wishes to stay anonymous. When User A downloads a new application for hiking, User A can share the identity of this new application anonymously with other people (e.g., the user 110) who are interested in hiking as well. In another example, a company employee wishes to discover the most popular application among other company employees, and ultimately discovers a corporate maps application for navigating the large corporate campus.

The disclosed architecture also facilitates collaborative-filtering-based application discovery. Users (e.g., the user 110 and the other users 116) can anonymously share one or more applications, even without creating a profile of interests, and get recommendations on relevant applications used by people who use similar applications. This can be accomplished by applying a collaborative-filtering approach to provide recommendations from others on applications that one might find interesting.

With respect to application popularity, a user may download an application, use the application only a few times, and in many cases, not bother to uninstall the application. Therefore, knowledge of an application download is not, by itself, the definitive indication of its popularity. To address this, the disclosed architecture can access additional application information (e.g., other user information 118 and/or the context information 104 of the device 108), which is useful. For example, an update can be obtained as to uninstalled applications and installed applications. Moreover, application usage can be identified to measure application popularity in an improved way.

Additionally, application usage can be measured and analyzed to determine which applications are not only used more/most frequently, but also, actually occupy more/most time with respect to user interaction. It can also be the case where there are very useful applications, which are rarely used (e.g., a parking payment application, a flashlight application, etc.). The user may use such programs infrequently (e.g., twice a month for only one minute), yet the applications is considered personally important. In these cases, a useful metric can be to measure the frequency or number of times such an application is launched (in contrast to only being installed) rather than the portion of the user interaction time the program occupies. With respect to sharing application information, the user can specify whether to share zero, one, or more of the download, uninstall, and usage information.

Accordingly, the discovery component 114 can access the other users 116 and associated other user information 118, which are of a social network, and discovers the suggested application 128. This access can be directly from the device 108 and/or in cooperation with external components/algorithms. The discovery component 114 accesses the other users 116 and associated other user information 118, which are of a geographical area and which other users 116 have knowledge of the geographical area, and discovers the suggested application 128.

The disclosed architecture also provides and enables privacy protection. This enables the users (e.g., the user 110 and the other users 116) to manage their privacy, even without sharing any identifying information. The user can choose to share an application identity or keep the application identity private. When the application identity is shared, the identity can be made “visible” to a permitted audience. Additionally, the user can control the visibility of the user profile by setting the desired privacy mode.

Accordingly, the context component 102 hides personal information of the context information 104 and exposes only user attributes and interests of the context information 104 such that the user is anonymous to the other users 116. The discovery component 114 shares the device application information anonymously to the other users 116 and receives from the other users 116 suggested applications (e.g., the suggested application 128) relevant to the context application 112.

The suggested application or applications can be presented to the user in a user interface for selection before installation, or installed automatically. The usage information can be obtained in substantially realtime (processed in the timespan that the actual event is occurring) from available users or obtained from an online service that obtains and stores the information on a regular basis for online access. The discovery process can occur based on only a foreground running application as the context application and/or for background running processes and applications. Foreground duration can also be an indicator of application usage.

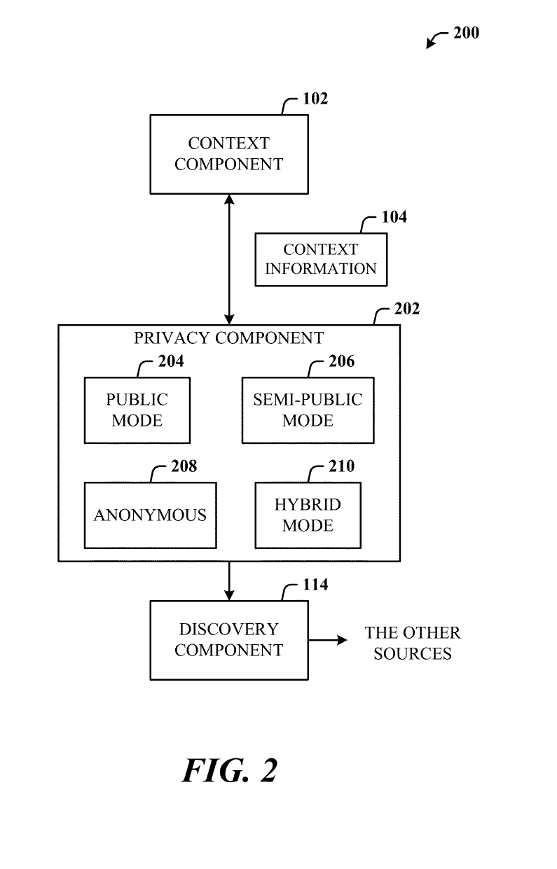

FIG. 2 illustrates a system 200 of privacy processing in accordance with the disclosed architecture for the authorized and secure handling of user information. The privacy component 202 enables the user to opt-in and opt-out of information exposure as well as managing some level of exposure of personal information. The user can be provided with notice that personal information may be exposed, for example, and the opportunity to manage privacy modes or deny consent to do so entirely.

The privacy modes include, but are not limited to, public mode 204, semi-public mode 206, anonymous mode 208, and hybrid mode 210. The public mode 204 exposes the user identity publicly and the applications the user shares are visible to the user's followers. In the semi-public mode 206, the user identity is not public, but shared applications are associated with the user profile attributes and interests. In the anonymous mode 208, the user profile is private and the list of applications is associated with the user's anonymous profile. In this case, the user can benefit from the collaborative-filtering recommendation. The hybrid mode 210 publicly shares the user applications with user followers, and also shares their applications anonymously with non-followers. For example, the user applications are shared anonymously with geographic locations to enable location-based application discovery.

The system 200 depicts the context component 102 deriving and outputting the context information 104 to a privacy component 202 for privacy processing. The privacy component 202 imposes the privacy settings (modes) either automatically or manually. The user can configure the privacy component 202 to automatically impose a single privacy mode for all instances of application discovery.

In an alternative implementation, a different privacy mode can be applied based on the type of discovery. For example, if the user is traveling to a different geographical area, and location-based application discovery is employed, the user may choose not to be operating in the fully public mode 204, but perhaps the semi-public mode 206 or the anonymous mode 208 when searching for a relevant application.

However, if the user employs social-based application discovery, the other users are likely to be friends or trusted users, in which case, the user may operate privacy in the public mode 204. Similarly, in collaborative filtering application discovery, the user may again want the anonymous mode 208 or even the hybrid mode 210 of privacy. As previously indicated, the hybrid mode 210 enables public exposure of the context information to friends and trusted users but anonymous exposure to other users the user does not know. In all cases, the applied privacy and context information is output to the discovery component 114 for communication to the other sources (e.g., other users, data sources, etc.).

In other words, the context component 102 enables configuration of privacy modes for the context information 104. The privacy modes control exposure of the personal information and the device application information to the other users 116. The discovery component 114 accesses application usage data of the other users 116 and discovers the suggested application 128 based on the usage data. The discovery component 114 accesses the other user information 118, which other user information 118 includes information related to at least one of updated applications, uninstalled applications, application sharing details, or actual user interaction time.

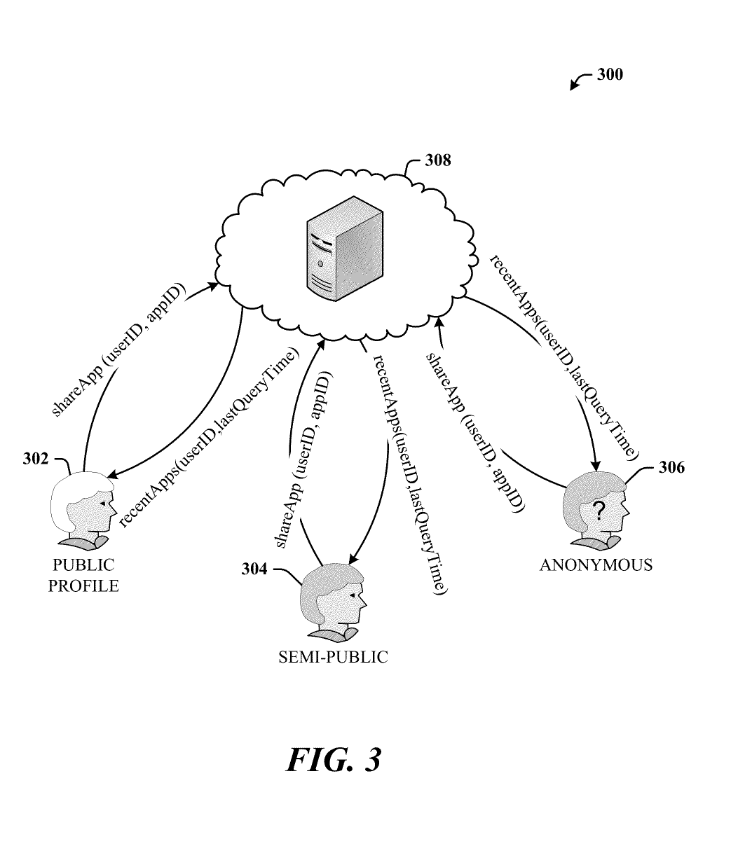

FIG. 3 illustrates a system 300 of an exemplary protocol for context information and privacy management. This is just one example of the information that can be passed to and received back for application discovery. Three users: a first user 302 using a public profile, a second user 304 using a semi-public profile, and a third user 306 using an anonymous profile, interact with one or more source(s) 308. Each user sends (from user devices, not shown) context information up to the source(s) 308, and receives suggested application information back (to the user devices, not shown). In this example, the protocol includes context information in a query of the form:

shareApp (userID, appID)

where shareApp can be a share function or expression that passes the userID, which is identifying information of the user, and the appID, which is identifying information of the context application.

In return, the source(s) 308 send back recent application information to the users (user devices) for selection of the suggested application (also referred to herein as the discovered application and relevant application). The recent application information can be of the form:

recentApps(userID,lastQueryTime)

where recentApps can be a function or expression that includes the userID to identify the requesting user, and the lastQueryTime, which indicates the most recent time that a query was made for the recent application information. Thus, the lastQueryTime can indicate that the recent application(s) are quite old relatively, in that the last query time indicates that input was a long time ago.

As previously indicated, other information that can be sent to the one or more other source(s) 308, can include any combinations of the following: user personal profile data (e.g., age, gender, profession, married, children, income, etc.), interests data (e.g., hobbies, indoor/outdoor activities, music, entertainment, etc., without personally identifying data as in the personal profile), preferences data (e.g., that may impose restrictions such as do not suggest a specific type or vendor application, do not suggest an application that exceeds a certain size, only suggest applications that are plug-in to a browser, only suggest free applications, only suggest applications that relate to a specific kind of music or event, etc.), geolocation data (e.g., latitude/longitude coordinates) that indicates the user location, and so on.

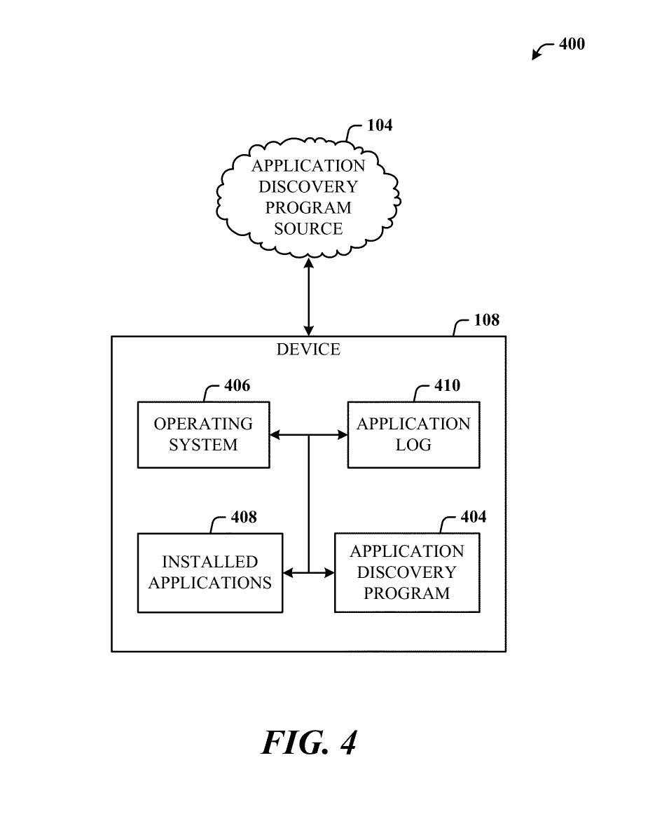

FIG. 4 illustrates a system 400 of application install and usage as a metric for application popularity. The device 108 interfaces to an online source 402 that can provide the application discovery program 404 as a download to the device 108, enable the application discovery program 404 as a web application that the user can access at any time, be provided as a download or web application upon access to an application store, etc.

The application discovery program 404 includes the context component 102 and the discovery component 114 (of FIG. 1), which generate and send the context information 104. The context application 112 is one of the install applications 408, and can be detected as the context application 112 by actually running at the time that discovery is initiated. For example, when starting a map navigation program, this sets the device context 106 as well as the context application 112, and on which the application discovery is based.

The application discovery program 404 can install like any standard program in conjunction with the operating system 406. The application discovery program 404 can also be provided (indirectly or directly) access to information about installed applications 408 and an application log 410. The log 410 serves to capture all application installs, uninstalls, application update installs, user activity for any given application, and so on.

Accordingly, the application discovery program 404 accesses at least the application log 410 as part of responding to discovery of the suggested application. This can be automatic response or user initiated response.

It is to be understood that the application discovery program 404 also “listens” for application discovery requests from the other users 116 to respond to application discovery from their associated devices/systems. It can be the case that the application discovery program 404 (specifically, the discovery component 114) includes both a broadcast function and a listening function that operate separately or together, periodically or continually. The device user can choose to be only a broadcaster to assist the discovery requests of the other users 116, rather than a listener to discover suggested application from the other users 116. The reverse is also true where the device user can choose to be only a listener to discover suggested application from the other users 116, rather than a broadcaster to assist the discovery requests of the other users 116.

The popularity of applications can be determined by many different methods are described herein, but in addition, based on geo-tagging and time-tagging information. Geo-tagged data adds geographical metadata to the specific data, such as a photograph. Thus, a photograph taken in the mountains can be tagged not only with time-tagged metadata (the time it was taken), but also the coordinates or some other geographical identification metadata such as the name of the mountains.

The discovery of popular media (e.g., text, video, images, audio, etc.) and the associated metadata on other networks, sources, user devices (e.g., camera phones, cameras, etc.) and systems, as compared to similar media and/or applications on the user device can indicate a suggested or relevant application.

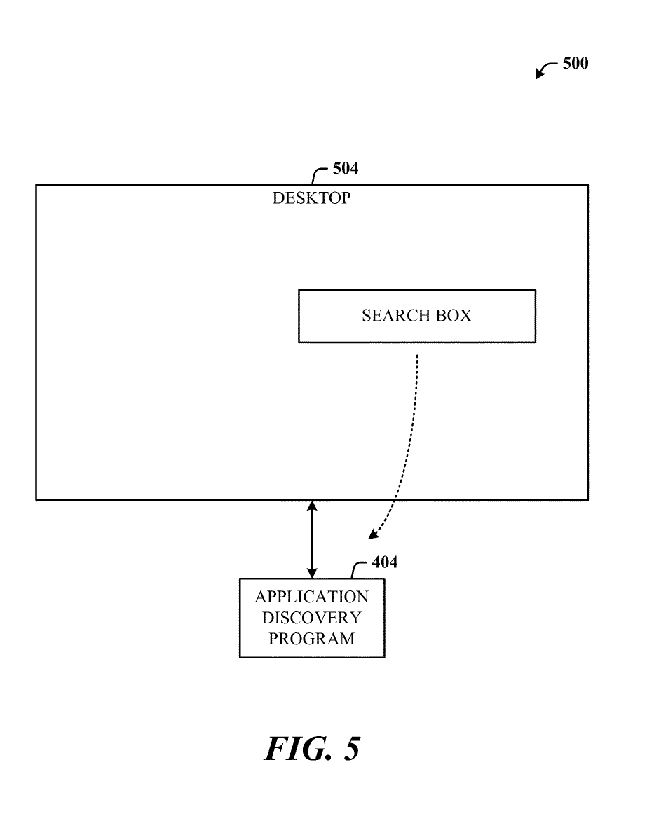

FIG. 5 illustrates a system 500 where the disclosed application discovery is incorporated with an operating system search capability. The capability to activate or deactivate the application discovery program 404 can be employed with a search box 502, for example. The search box 502 can be presented on a desktop 504 and utilized to receive query terms to search not only in local applications such as the one currently open, but information and applications of the local device, and online sources and users as well. Thus, if the user searches to find an application to launch locally, this can also be a discovery request to automatically find relevant applications as suggested by other users and sources, and discovery methods. For example, a web search by the user for mapping software to navigate a new geographical area can result in discovery of a more localized map/application for the area as well as popular sites of interest.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

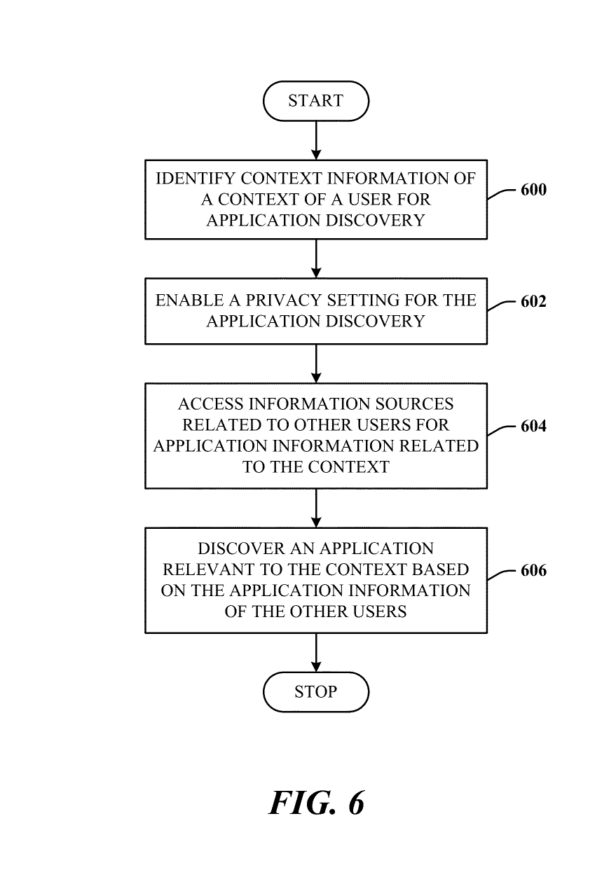

FIG. 6 illustrates a method in accordance with the disclosed architecture. At 600, context information of a context of a user is identified for application discovery. For example, the context can be that the user in a geographical area, and the context information includes the geographical coordinates of the user (user device) in the geographical area. Accordingly, the method can further comprise accessing an information source that is a location-based source of a geographical area and based on which the application is discovered using application information of other users having knowledge of the geographical area. This knowledge can be obtained directly from the other users, or accessed from a data store that stores such information. At 602, a privacy setting is enabled for the application discovery. The privacy setting (profile) can be one of public, semi-public, anonymous, or hybrid.

At 604, information sources related to other users are accessed for application information related to the context. The information sources can be social networks of which some members are trusted friends, family, others unknown to the user but who have similar interests, computing devices/systems of other user devices and systems, etc. The application information includes install/uninstall information feedback, frequency-of-use data for applications of the other users, direct replies from the other users as to their preferred application(s) for use in the context, stored information from websites and social networks, and so on. Accordingly, the method can further comprise accessing an information source that is a social network of other users and based on which the application is discovered using application information of the other users.

At 606, an application relevant to the context is discovered based on the application information of the other users. Once the application information is returned to the user, the user can review and make a selection (“discover”) of one or more of the associated applications. Alternatively, the discovery component 114 can operate to automatically select the application(s) (“discover” the application(s)) for the user based on a ranked set of applications, or outright select the top popular application(s) based on a finite set of responses from users, for example. It can also be the case that application discovery is performed in the “cloud” and communicated to the discovery component 114 for either automatic install or managed install by the user.

The method can further comprise limiting exposure of the context information to the other users based on the setting (profile), for privacy concerns, and accessing the information sources related to the other users for application information based on the privacy setting. The user may have a single profile or multiple profiles. The single profile may include all information about the user, such as user identity, preferences, interests, age, gender, other online memberships, frequented blogs, political affiliation, religious affiliation, and so on.

It can be the case that for privacy concerns, this single profile can be automatically parsed into the various levels of user information exposure. For example, if the user chooses to allow the user information to be “wide open”—fully publically accessible—then the entire single file is open to the public. Alternatively, if the user chooses to be semi-public, certain user information of the file is parsed for exposure and the remaining parts are protected from exposure. As previously mentioned, the system may also configure separate user profile files, in which case, after user entry and storage, the system simple selects the appropriate profile file based on the user-selected privacy mode. Accordingly, the method can further comprise anonymously sharing identity of an application associated with the context, with the other users, and receiving suggested applications from the other users that are relevant to the application identity.

The method can further comprise measuring application popularity by the other users based on usage of the application by the other users. The usage data can be obtained indirectly from users via device/systems (e.g., smartphones, tablets, laptops, etc.) of the other users, such as from operating system files/programs, for example. The usage data also can be obtained directly from the other users who respond to, a query or request, for example, as to how often the application is used.

The method can further comprise accessing the sources of the other user information, which other user information includes information related to at least one of updated applications, uninstalled applications, application sharing details, or user interaction time with an application. The sources of other user information can be device/systems (e.g., smartphones, tablets, laptops, etc.) of the other users, such as from application log files and operating system programs for install, uninstall, and use activity, for example. The application install, uninstall, and update activity data can also be obtained directly from the other users who respond to how often the application is used.

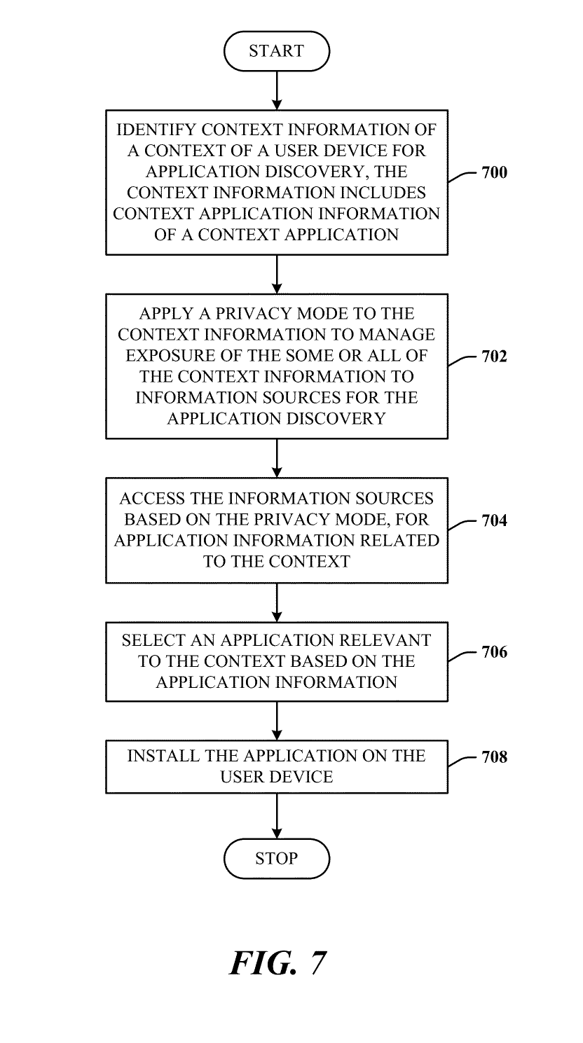

FIG. 7 illustrates an alternative method in accordance with the disclosed architecture. At 700, context information of a context of a user device is identified for application discovery. The context information includes context application information of a context application. At 702, a privacy mode is applied to the context information to manage exposure of the some or all of the context information to information sources for the application discovery. At 704, the information sources are accessed based on the privacy mode, for application information related to the context. At 706, an application relevant to the context is selected based on the application information. At 708, the application is installed on the user device.

The method can further comprise selecting the application based on an information source that includes friends or people of a social network having similar interests. The method can further comprise sharing the context application information with the information sources and receiving suggestions for an application similar to the context application. The method can further comprise selecting the application based on anonymous sharing of user interests and profile attributes, in accordance with a privacy mode. The method can further comprise obtaining actual usage data from the information sources and selecting the application based on the actual usage by other users.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

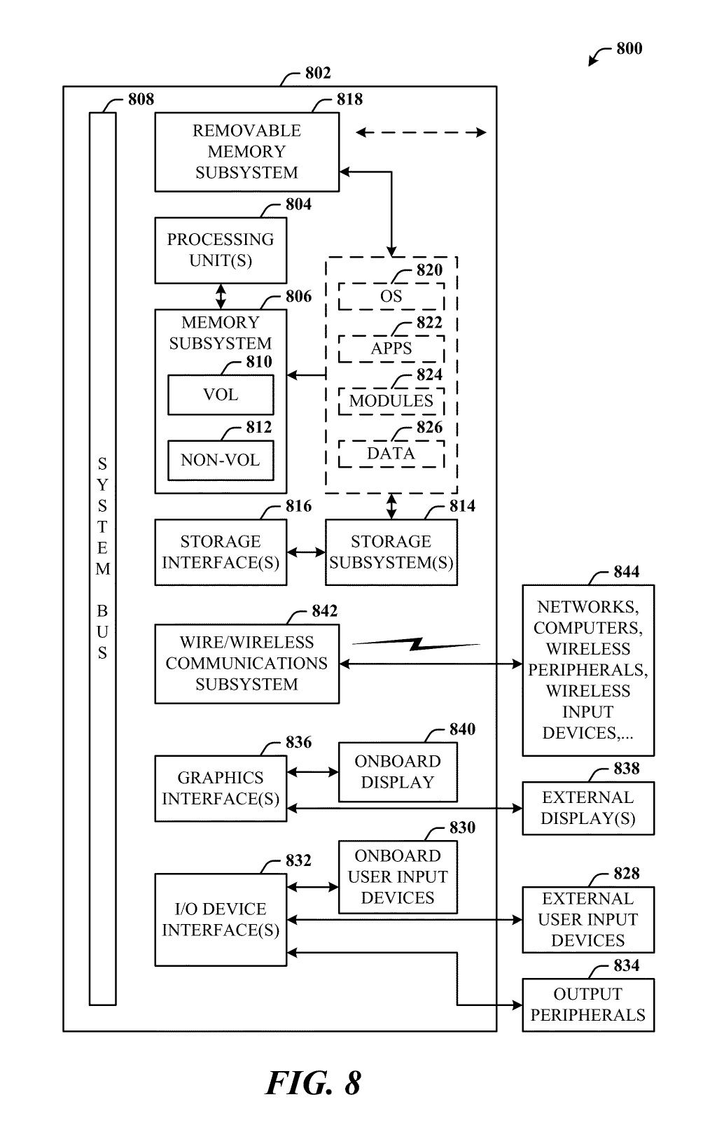

Referring now to FIG. 8, there is illustrated a block diagram of a computing system 800 that executes application discovery in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804 (also referred to as microprocessor(s) and processor(s)), a computer-readable storage medium such as a system memory 806 (computer readable storage medium/media also include magnetic disks, optical disks, solid state drives, external memory systems, and flash memory drives), and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 802 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 806 can include computer-readable storage (physical storage) medium such as a volatile (VOL) memory 810 (e.g., random access memory (RAM)) and a non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The operating system 820, one or more application programs 822, other program modules 824, and/or program data 826 can include entities and components of the system 100 of FIG. 1, entities and components of the system 200 of FIG. 2, entities and components of the system 300 of FIG. 3, entities and components of the system 400 of FIG. 4, entities and components of the system 500 of FIG. 5, and the methods represented by the flowcharts of FIGS. 6 and 7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 802, and include volatile and non-volatile internal and/or external media that is removable and/or non-removable. For the computer 802, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 802, programs, and data using external user input devices 828 such as a keyboard and a mouse, as well as by voice commands facilitated by speech recognition. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example.

These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a context component that identifies context information of a device context of a user, the context information includes personal information and device application information of a context application;
a discovery component that accesses other users and associated other user information according to a privacy profile, and discovers a suggested application relevant to the device context based in part on the context information; and
a microprocessor that executes computer-executable instructions associated with at least one of the context component or the discovery component.

2. The system of claim 1, wherein the discovery component accesses the other users and associated other user information, which are of a social network, and discovers the suggested application.

3. The system of claim 1, wherein the discovery component accesses the other users and associated other user information, which are of a geographical area and which other users have knowledge of the geographical area, and discovers the suggested application.

4. The system of claim 1, wherein the context component hides personal information of the context information and exposes only user attributes and interests of the context information such that the user is anonymous to the other users.

5. The system of claim 1, wherein the discovery component shares the device application information anonymously to the other users and receives from the other users suggested applications relevant to the context application.

6. The system of claim 1, wherein the context component enables configuration of privacy modes for the context information, the privacy modes control exposure of the personal information and the device application information to the other users.

7. The system of claim 1, wherein the discovery component accesses application usage data of the other users and discovers the suggested application based on the usage data.

8. The system of claim 1, wherein the discovery component accesses the other user information, which other user information includes information related to at least one of updated applications, uninstalled applications, application sharing details, or actual user interaction time.

9. A method performed by a computer system executing machine-readable instructions, the method comprising acts of:
identifying context information of a context of a user for application discovery;
enabling a privacy setting for the application discovery;
accessing information sources related to other users for application information related to the context based on the privacy setting; and
discovering an application relevant to the context based on the application information of the other users.

10. The method of claim 9, further comprising accessing an information source that is a social network of other users and based on which the application is discovered using application information of the other users.

11. The method of claim 9, further comprising accessing an information source that is a location-based source of a geographical area and based on which the application is discovered using application information of other users having knowledge of the geographical area.

12. The method of claim 9, further comprising limiting exposure of the context information to the other users based on the privacy setting, for privacy concerns, and accessing the information sources related to the other users for application information based on the privacy setting.

13. The method of claim 9, further comprising anonymously sharing identity of an application associated with the context, with the other users, and receiving suggested applications from the other users that are relevant to the application identity.

14. The method of claim 9, further comprising measuring application popularity by the other users based on usage of the application by the other users.

15. The method of claim 9, further comprising accessing the sources of the other user information, which other user information includes information related to at least one of updated applications, uninstalled applications, application sharing details, or user interaction time with an application.

16. A computer-readable medium comprising computer-executable instructions that when executed by a processor, cause the processor to perform acts of:
identifying context information of a context of a user device for application discovery, the context information includes context application information of a context application;
applying a privacy mode to the context information to manage exposure of the some or all of the context information to information sources for the application discovery;
accessing the information sources based on the privacy mode, for application information related to the context;
selecting an application relevant to the context based on the application information; and
installing the application on the user device.

17. The computer-readable medium of claim 16, further comprising selecting the application based on an information source that includes friends or people of a social network having similar interests.

18. The computer-readable medium of claim 16, further comprising sharing the context application information with the information sources and receiving suggestions for an application similar to the context application.

19. The computer-readable medium of claim 16, further comprising selecting the application based on anonymous sharing of user interests and profile attributes, in accordance with a privacy mode.

20. The computer-readable medium of claim 16, further comprising obtaining actual usage data from the information sources and selecting the application based on the actual usage by other users.
